(19) United States
(12) Patent Application Publication
(10) Pub. No.: US 2026/0339032 A1
(43) Pub. Date: Oct. 29, 2026

(54) RECONFIGURABLE OPTICAL FILTER TO SEPARATE CARRIER AND SIDEBAND

(71) Applicant: GlobalFoundries U.S. Inc., Malta, NY (US)

(72) Inventor: Aneesh Dash, Bangalore (IN)

(21) Appl. No.: 19/188,449

(22) Filed: Apr. 24, 2025

(51) Int. Cl. G02B 6/293

(52) U.S. Cl. CPC G02B 6/29353; G02B 6/29343; G02B 6/29389

(57) ABSTRACT

An optical filter structure and method of forming the same. The structure includes a first waveguide having an input port and a first output port; a second waveguide having a second output port; a first micro-ring resonator (MRR) directionally coupled to the first waveguide and the second waveguide, the first MRR implemented to transfer first predefined wavelengths from the first waveguide to the second waveguide in a first rotational direction; and a second MRR implemented to exchange second predefined wavelengths between the first waveguide and the second waveguide in a second rotational direction opposite the first rotational direction.

### BACKGROUND

The present disclosure relates to optical filters and, more particularly, to a micro-ring resonator-based circuit for separating optical carrier and sideband signals.

Photonic chips are used in many applications and systems including, but not limited to, communication systems and data computation systems. A photonic chip includes a photonic integrated circuit comprised of photonic components, such as resonators, modulators, polarizers, and couplers, that are used to manipulate light received from a light source, such as a laser or an optical fiber.

Optical resonators are devices that can be used to spatially confine resonant optical energy in a limited cavity with a low optical loss. The resonance of an optical resonator may be used to provide various useful functions such as optical filtering, optical modulation, optical amplification, optical delay, generation of oscillation signals and others. Light can be coupled into or out of optical resonators via various coupling mechanisms according to the configurations of the resonators.

### SUMMARY

Disclosed herein are embodiments of a micro-ring resonator-based optical circuit for separating carrier and sideband signals.

Illustrative aspects include a structure having a first waveguide having an input port and a first output port; a second waveguide having a second output port; a first micro-ring resonator (MRR) directionally coupled to the first waveguide and the second waveguide, the first MRR implemented to transfer first predefined wavelengths from the first waveguide to the second waveguide in a first rotational direction; and a second MRR implemented to exchange second predefined wavelengths between the first waveguide and the second waveguide in a second rotational direction opposite the first rotational direction.

Other aspects include a method of forming a structure for a micro-ring resonator (MRR) filter, the method comprising: forming a first waveguide that includes an input port and a first output port; forming a second waveguide that includes a second output port, wherein the second waveguide includes a first portion and a second portion, and wherein the first portion is oriented in a direction opposite the second portion; forming a first MRR coupled in a first direction to the first waveguide and the first portion of the second waveguide; and forming a second MRR coupled to the second waveguide and the first waveguide in a second direction opposite the first direction.

Two or more aspects described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

The present disclosure will be better understood from the following detailed description with reference to the drawings, which are not necessarily drawn to scale and in which:

FIG. 1 depicts a micro-ring resonator-based circuit for separating optical carrier and sideband signals, according to embodiments;

FIG. 2 depicts signal diagrams of the circuit of FIG. 1, according to embodiments;

FIG. 3 depicts an alternative micro-ring resonator-based circuit utilizing Mach-Zehnder interferometers (MZIs), according to embodiments; and

FIG. 4 depicts a further alternative micro-ring resonator-based circuit utilizing Mach-Zehnder interferometers (MZIs) and feedback control, according to embodiments.

It is noted that the drawings of the disclosure are not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION

As noted, optical resonators provide various useful functions including optical filtering. In the various aspects described herein, optical filtering is deployed in photonic devices such as optical transceivers to separate carrier signals from the modulated data contained in sideband signals. A carrier signal is for example a periodic waveform (e.g., sinusoidal) that carries information through a process called modulation, while sidebands are the frequency bands above and below the carrier frequency that contain the modulated information. Depending on the implementation and types of signals being processed, different filtering strategies may be needed. For example, high power optical carrier signals can saturate receiver electronics and have nonlinear optical effects, which may require different filtering requirements from lower power signals. Accordingly, reconfigurable optical filters to separate carrier and sideband signals are provided herein.

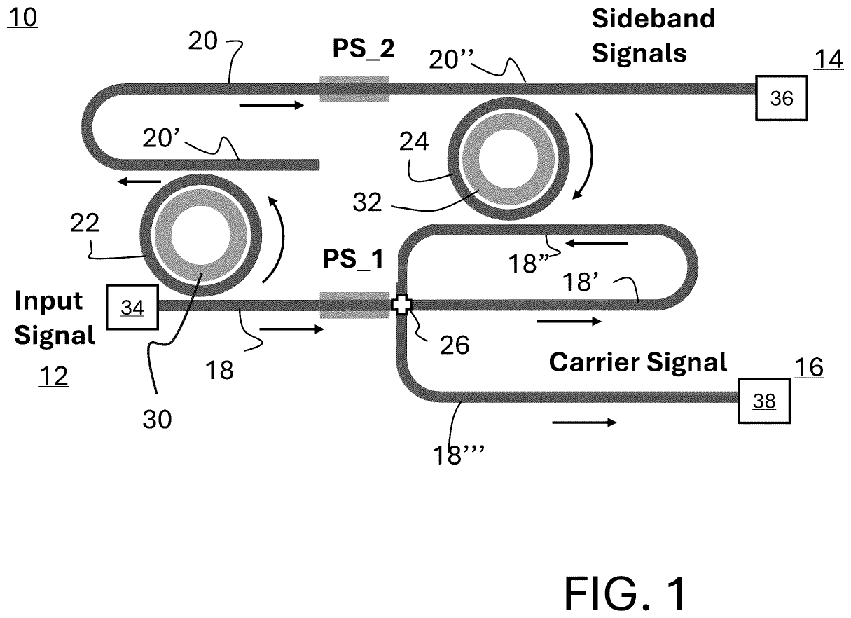

FIG. 1 depicts a structure having an optical circuit for implementing an optical filter 10. Optical filter 10 includes a first waveguide 18, a second waveguide 20, and cascaded micro-ring resonators (MRRs) 22, 24. Optical filter 10 is configured to receive an optical input signal 12 at an input port 34, filter the input signal 12, and separately output sideband signals 14 and a carrier signal 16 at a pair of output ports 36, 38, respectively. The input signal 12, which may for example include a composite signal with both carrier and sideband signals, is initially fed to a first waveguide 18. A first micro-ring resonator (MRR) 22 is directionally coupled between waveguide 18 and waveguide 20 and is implemented to transfer predefined wavelengths from waveguide 18 to waveguide 20 in a first rotational direction (as shown by the arrow). A second MRR 24 is directionally coupled between waveguide portion 20″ (of waveguide 20) and waveguide portion 18″ (of waveguide 18) and is implemented to exchange predefined wavelengths between waveguide portion 20″ and waveguide portion 18″ in a second rotational direction opposite the first rotational direction (as shown by the arrow). Directional coupling may for example be implemented with a directional coupler, which is a device that uses two closely spaced waveguides to transfer light between them in a defined direction, allowing for splitting or combining light signals in photonic circuits.

MRRs 22, 24 each comprise a looped waveguide structure that selectively filters certain wavelengths of light by leveraging the resonant behavior of light within the ring. Namely, the length of the path in the ring (as well as the refractive index of the material used) determines which wavelengths will be filtered. Further, each MRR 22, 24 may include a phase shifter 30, 32, respectively that further controls the filtering. In this case, the first MRR 22 is configured to filter (i.e., collect) selected wavelengths from the waveguide 18 while allowing other wavelengths to pass along waveguide 18. For example, first MRR 22 may be configured to filter the carrier signal from waveguide 18 and direct it to waveguide 20, and allow the sidebands to be distributed in both waveguides 18 and 20. In this embodiment, the filtered light rotates within MRR 22 in a counter-clockwise direction and filtered light in the second MRR 24 rotates in a clockwise direction, opposite the light rotation in the first MRR 22. Second MRR 24 is also directionally coupled to waveguide 18, which causes the filtered light in second MRR 24 to be exchanged between waveguides 18 and 20. For example, before reaching the second MMR 24, waveguide 18 has only sideband signals while waveguide 20 has carrier and sidebands. The second MRR 24 filters out carrier signals from waveguide 20 and transfers it onto waveguide 18 towards port 38 and collects sidebands from waveguide 18 and transfers the combined sideband signals from waveguide 18 and 20 towards port 36.

In order to accommodate opposite rotations in the two MRR, waveguides 18 and 20 reverse directions. For example, waveguide 20 includes two portions 20′ and 20″, which are oriented (i.e., carry the light) in opposite directions, i.e., waveguide 20 reverses direction between MRR 22 and MRR 24. Waveguide 18 reverses direction between the first MRR 22 and the second MRR 24, and reverses direction again between the second MRR 24 and output port 38. This is shown with waveguide portions 18′, 18″, and 18′″, in which waveguide 18 first reverses direction between portions 18′ and 18″, and the reverses direction between portions 18″ and 18′″. Waveguide 18 further includes a crossing 26 that ensures the signals do not interfere.

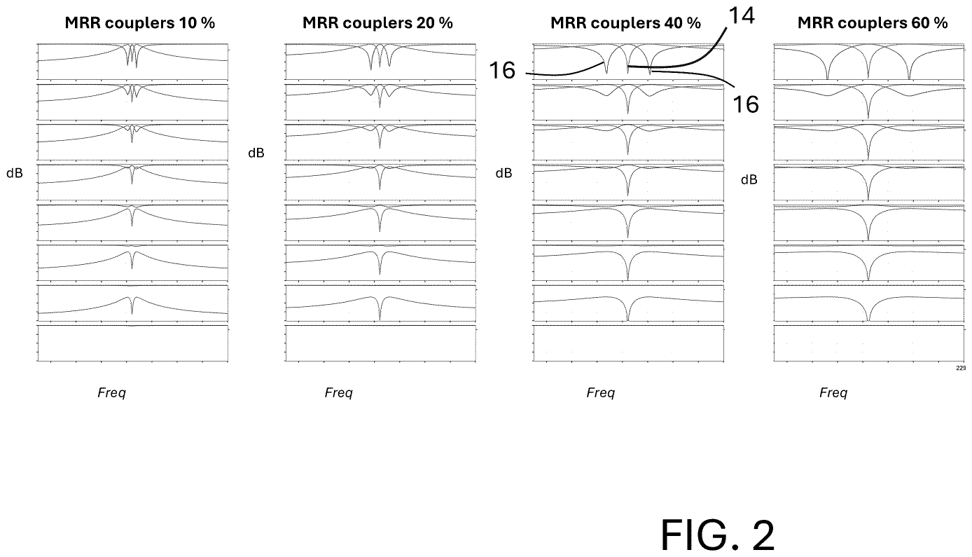

The optical filter 10 can be tuned using phase shifters and coupling distances. As shown, both waveguides 18, 20 have phase shifters PS_1, PS_2, respectively, to configure the attenuation of the carrier and sideband outputs. Each phase shifter is capable of changing the phase/velocity of the traveling. Namely, the phase of the signal that is dropped and the phase of the signal that is passed through the first MRR 22 can be altered based on the amount of phase shift provided in PS_1, PS_2. Additionally, filter 10 can be further tuned based on the amount of coupling used for the MRRs 22, 24. For example, FIG. 2 depicts four illustrative waveform simulations with the MRRs coupled at 10%, 20%, 40%, and 60%, going from left-to-right. As can be seen, the side bands 16 have a wider frequency spread as the coupling increases. The waveforms going from top to bottom show the attenuation effect of increased phase shifting. Accordingly, the amount of coupling and phase-shifting can be tuned to achieve a desired filtering result for a given application.

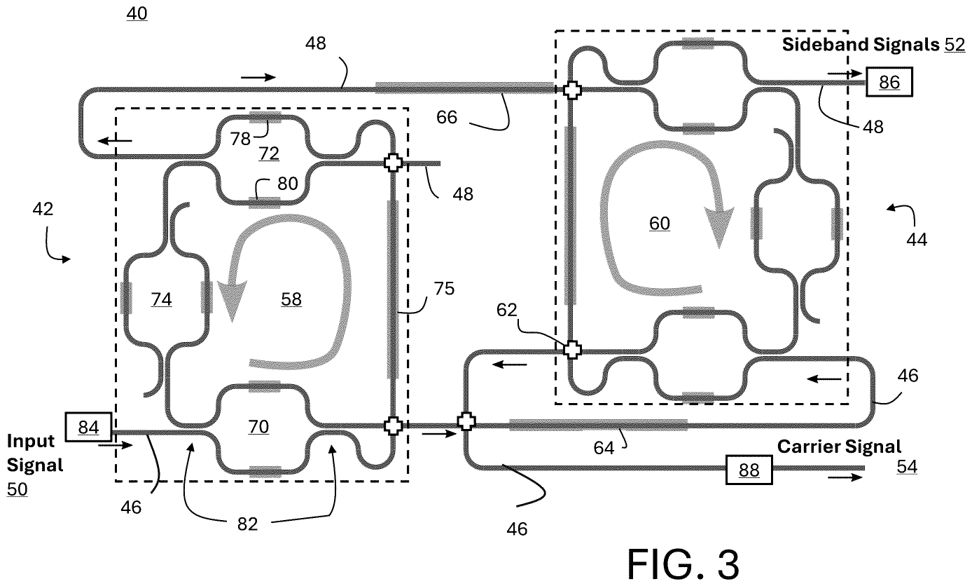

FIG. 3 depicts an alternative embodiment of an optical filter 40 in which Mach-Zehnder interferometer (MZI) structures 42, 44 are utilized to provide enhanced MRRs, e.g., to achieve advanced spectral filtering. MZI structures are known in the art and are therefore not described herein in detail. Optical filter 40 includes the same overall signal flow as the filter 10 shown in FIG. 1. Namely, filter 40 receives an input signal 50 at an input port 84 of a first waveguide 46 that is coupled to a first MZI structure 42, which filters selected wavelengths in a counter-clockwise direction as shown by arrow 58. A remaining portion of the input signal 50 is allowed to pass along waveguide 46.

A second waveguide 48 receives the filtered wavelengths via directional coupling from the first MZI structure 42. First waveguide 46 and second waveguide 48 are further directionally coupled to a second MZI structure 44, which further filters signals in a clockwise direction as shown by arrow 60. A resulting carrier signal 54 on waveguide 46 is accordingly transmitted to output port 88 and sideband signals are transmitted on waveguide 48 to output port 86. A crossover 62 is provided to ensure that the two paths in waveguide 46 do not interfere with each other. Similar to the embodiment of FIG. 1, first waveguide 46 includes a first phase shifter 64 and second waveguide 48 includes a second phase shifter 66, which can be tuned to control the spectral response.

In this embodiment, the first and second MZI structures 42, 44 are essentially the same and operate in a similar manner, except they are oriented opposite of each other such that the light propagates in opposite directions as shown by arrows 58 and 60. MZI structure 42 generally includes a set of MZIs (in this example three MZIs) 70, 72, 74 and a ring phase shifter 75. Each MZI includes directional couplers (not shown) located, e.g., at locations 82 of MZI 70 to allow selected wavelengths of light to leak between adjacent waveguides. Details of the directional couplers are well understood in the art and therefore omitted herein for brevity purposes. Additionally, each MZI 70, 72, 74 may include one or more MZI phase shifters such as phase shifters 78, 80 shown for MZI 72. The ring phase shifter 75 may be used to individually adjust the phase of light propagating in the MZI structure 42, whereas MZI phase shifters 78, 80 may be used to individually adjust the phase of light propagating in each MZI. In this illustrative embodiment, MZI 70 controls an amount of light that will propagate between waveguide 46 and MZI structure 42. Similarly, MZI 72 controls an amount of light that will propagate between MZI structure 42 and waveguide 46. MZI 74 controls the wavelength, e.g., the width or narrowness thereof. (As noted, MZI structure 44 operates similarly to MZI structure 42, so details are omitted for brevity.) Similar to the embodiment of FIG. 1, the various phase shifters and couplers can be tuned to achieve a desired spectral result.

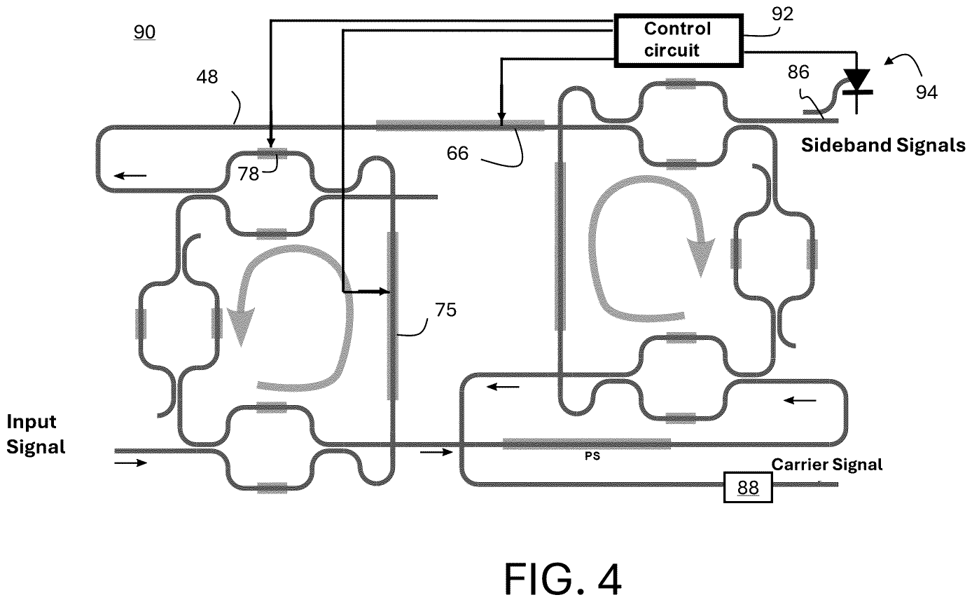

FIG. 4 depicts a further embodiment of an optical filter 90 that is essentially the same as the embodiment of FIG. 3, except a control circuit 92 is utilized to control one or more of the phase shifters based on feedback, e.g., an electrical signal obtained from a photodetector 94 located proximate output port 86 (and/or output port 88). For example, based on an amplitude of the carrier signal, control circuit 92 can adjust selected phase shifters. For example, control circuit 92 could be utilized to select arbitrary sidebands and maximize separation of sidebands and carriers. In this example, control circuit 92 controls phase shifter 66 on waveguide 48, ring phase shifter 75, and MZI phase shifter 78, which optimizes an amount of phase shift at those locations. However, it is understood that other phase shifters could likewise be controlled.

It is understood that the particular implementation of the MZIs in FIGS. 3 and 4 are for illustrative purposes and other implementations could be utilized. For example, while each MZI is shown with two combining paths, more than two combining paths could be used. Further, any order of MZIs could be used.

Further, it is understood that any waveguide material can be used in any of the embodiments, e.g., as Si, SiN, SiON, AlN, GaN, III-V, Diamond, TFLN, BTO, etc. Similarly, any type of phase shifter may be used, e.g., thermo-optic, electro-optic, TFLN, BTO, 2D material, optomechanical (MEMS/NEMS), etc. Likewise, any type of optical splitter or combiner may be used, e.g., thermo-optic, electro-optic, TFLN, BTO, 2D material, optomechanical (MEMS/NEMS), etc.

Methods of forming the structures described herein may include any process of fabricating integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

It should be understood that the terminology used herein is for the purpose of describing the disclosed structures and methods and is not intended to be limiting. For example, as used herein, the singular forms “a,” “an” and “the” are intended to include the plural forms as well, unless the context clearly indicates otherwise. Additionally, as used herein, the terms “comprises,” “comprising,” “includes” and/or “including” specify the presence of stated features, integers, steps, operations, elements, and/or components, but do not preclude the presence or addition of one or more other features, integers, steps, operations, elements, components, and/or groups thereof. Furthermore, as used herein, terms such as “right,” “left,” “vertical,” “horizontal,” “top,” “bottom,” “upper,” “lower,” “under,” “below,” “underlying,” “over,” “overlying,” “parallel,” “perpendicular,” etc., are intended to describe relative locations as they are oriented and illustrated in the drawings (unless otherwise indicated) and terms such as “touching,” “in direct contact,” “abutting,” “directly adjacent to,” “immediately adjacent to,” etc., are intended to indicate that at least one element physically contacts another element (without other elements separating the described elements). The term “laterally” is used herein to describe the relative locations of elements and, more particularly, to indicate that an element is positioned to the side of another element as opposed to above or below the other element, as those elements are oriented and illustrated in the drawings. For example, an element that is positioned laterally adjacent to another element will be beside the other element, an element that is positioned laterally immediately adjacent to another element will be directly beside the other element, and an element that laterally surrounds another element will be adjacent to and border the outer sidewalls of the other element. The corresponding structures, materials, acts, and equivalents of all means or step plus function elements in the claims below are intended to include any structure, material, or act for performing the function in combination with other claimed elements as specifically claimed.

The descriptions of the various disclosed embodiments have been presented for purposes of illustration but are not intended to be exhaustive or limiting. Many modifications and variations will be apparent to those of ordinary skill in the art without departing from the scope and spirit of the disclosed embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure, comprising:
a first waveguide having an input port and a first output port;
a second waveguide having a second output port;
a first micro-ring resonator (MRR) directionally coupled to the first waveguide and the second waveguide, the first MRR implemented to transfer first predefined wavelengths from the first waveguide to the second waveguide in a first rotational direction; and
a second MRR implemented to exchange second predefined wavelengths between the first waveguide and the second waveguide in a second rotational direction opposite the first rotational direction.

2. The structure of claim 1, wherein at least one of the first waveguide and the second waveguide includes a phase shifter.

3. The structure of claim 1, wherein at least one of the first MRR and the second MRR includes a phase shifter.

4. The structure of claim 1, wherein the second waveguide reverses direction between the first MRR and the second MRR.

5. The structure of claim 1, wherein the first waveguide reverses direction between the first MRR and the second MRR, and reverses direction again between the second MRR and the first output port.

6. The structure of claim 5, wherein the first waveguide includes a crossover.

7. The structure of claim 1, wherein the first MRR and the second MRR comprise Mach-Zehnder interferometer (MZI) structures.

8. The structure of claim 7, wherein the first MRR and the second MRR each include a plurality of MZIs, and wherein each MZI includes at least one phase shifter.

9. The structure of claim 8, further comprising a control circuit coupled with at least one phase shifter, wherein the control circuit is electrically coupled to a photodetector.

10. The structure of claim 9, wherein the control circuit adjusts the at least one phase shifter in response to an electrical signal from the photodetector.

11. The structure of claim 10, wherein the photodetector is located proximate at least one of the first output port and the second output port.

12. The structure of claim 11, wherein the control circuit controls:
a first phase shifter on the second waveguide;
a ring phase shifter in the first MRR; and
an MZI phase shifter in an MZI in the first MRR.

13. The structure of claim 1, wherein the structure comprises an optical filter for separating an input signal into a carrier signal and sidebands signals.

14. The structure of claim 13, wherein the first waveguide outputs the carrier signal and the second waveguide outputs sideband signals.

15. The structure of claim 14, wherein the first MRR is configured to:
filter the carrier signal from the first waveguide;
transfer the sideband signals and the carrier signal from the input signal on the first waveguide to the second waveguide; and
allow the sideband signals to pass along the first waveguide.

16. The structure of claim 15, wherein the second MRR is configured to:
filter the carrier signal from the second waveguide;
transfer the carrier signal from the second waveguide to the first waveguide;
filter the sideband signals from the first waveguide; and
transfer the sideband signals from the first waveguide to the second waveguide.

17. A method of forming a structure for a micro-ring resonator (MRR) filter, the method comprising:
forming a first waveguide that includes an input port and a first output port;
forming a second waveguide that includes a second output port, wherein the second waveguide includes a first portion and a second portion, and wherein the first portion is oriented in a direction opposite the second portion;
forming a first MRR coupled in a first direction to the first waveguide and the first portion of the second waveguide; and
forming a second MRR coupled to the second waveguide and the first waveguide in a second direction opposite the first direction.

18. The method of claim 17, wherein the first waveguide includes a first portion, a second portion, and a third portion, wherein the first portion of the first waveguide is oriented in a direction opposite the second portion of the first waveguide.

19. The method of claim 18, wherein the second portion of the first waveguide is oriented in a direction opposite the third portion of the first waveguide.

20. The method of claim 17, wherein the first MRR and the second MRR comprise Mach-Zehnder interferometer (MZI) structures.
